(19) United States
(12) Patent Application Publication
(10) Pub. No.: US 2008/0149682 A1
(43) Pub. Date: Jun. 26, 2008

(54) STRUCTURE OF STAPLE MAGAZINE HAVING PERMANENT MAGNET

(76) Inventor: Hyun Duk Uhm, Seoul (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/946,357

(22) Filed: Nov. 28, 2007

(30) Foreign Application Priority Data
Dec. 21, 2006 (KR) 10-2006-0132481

(51) Int. Cl. B25C 5/16

(52) U.S. Cl. 227/120

(57) ABSTRACT

The present invention uses the principle in which staples made of iron are attracted in a direction in which magnetic attraction force is generated. Using this principle, a permanent magnet is provided on a front wall of a staple magazine, so that a staple cartridge is attracted towards an ejection slot of the staple magazine by the magnetic attraction force of the permanent magnet. When a handle having a punching blade is pushed, the frontmost staple in the staple cartridge, which is aligned with the ejection slot, is ejected by the punching blade to staple paper sheets. After the frontmost staple is ejected, the staple cartridge is automatically moved to and brought into close contact with the front wall of the staple magazine such that a subsequent staple, which is in a frontmost position, is aligned with the ejection slot to prepare for a subsequent stapling operation.

### FIELD OF THE INVENTION

The present invention relates generally to staple magazines for staplers and, more particularly, to a structure of a staple magazine for staplers in which a permanent magnet is provided on the front end of the staple magazine, so that, using the principle in which staples, that is, a staple cartridge, made of iron, are attracted in the direction from which magnetic attraction force is generated, the permanent magnet conducts the same function as that of a spring structure of a conventional stapler, in which a staple cartridge contained in the staple magazine is pushed by the restoring force of the spring.

### DESCRIPTION OF THE RELATED ART

Generally, as shown in FIG. 1, a conventional stapler 10 includes a spring structure, which includes a spring 2, a spring guide rod 4, a tension lever and a guide block 6 for pushing a staple cartridge 50 contained in a staple magazine 60. To staple paper sheets, a frontmost staple 52 of the staple cartridge is ejected outside through an ejection slot of the staple magazine 60. Then, the staple cartridge, which is in the staple magazine 60, is automatically pushed to and is brought into close contact with the front wall of the staple magazine adjacent to the ejection slot by the pushing force of the spring 2. To load a staple cartridge 50 into the staple magazine 60, physical force must be applied to the spring structure such that space for loading is created between the front wall of the staple magazine and the guide block 6. At this time, an excessive load may be applied to the finger of a user. As such, the conventional stapler has a structural disadvantage in that the use thereof is inconvenient to the user.

Furthermore, there are disadvantages in that, because the spring structure of the staple magazine 60 includes the spring 2, the spring guide rod 4, the tension lever and the guide block 6, the weight of the stapler is increased, and the structure of the stapler is complicated, so that the process of manufacturing the stapler is also complicated.

### SUMMARY OF THE INVENTION

Accordingly, the present invention has been made keeping in mind the above problems occurring in the prior art, and an object of the present invention is to provide a structure of a staple magazine for staplers which uses the principle in which staples, made of iron, are attracted in the direction from which magnetic force is generated, and, in detail, in which a permanent magnet is provided on the front wall of the staple magazine adjacent to an ejection slot, through which a frontmost staple of a staple cartridge is ejected outside to bind paper sheets, so that the staple cartridge is biased to and is brought into contact with the front wall of the staple magazine by the magnetic attraction force of the permanent magnet, in other words, when the frontmost staple of the staple cartridge is ejected from the staple magazine to staple the paper sheets, the staple cartridge is automatically moved to and is brought into close contact with the front wall of the staple magazine adjacent to the ejection slot by the magnetic attraction force of the permanent magnet in order to prepare for a subsequent stapling operation.

In order to accomplish the above object, the present invention provides a structure of a staple magazine for a stapler, including a base having on a front end thereof an anvil for bending a staple, a lower surface of the base being covered with a cover, a support provided on a rear end of the base, the support having opposite sidewalls, the staple magazine coupled at a rear end thereof to inner surfaces of the sidewalls of the support so as to be rotatable, the staple magazine containing a staple cartridge therein, and a handle for covering an upper part of the staple magazine, the handle being rotatably coupled at a rear end thereof to the sidewalls of the support, with a punching blade provided in the handle, wherein a front permanent magnet is provided on the front wall of the staple magazine, which contains the staple cartridge therein, at a predetermined position adjacent to an ejection slot formed in the staple magazine, so that the staple cartridge is attracted towards the ejection slot of the staple magazine by the magnetic attraction force of the front permanent magnet, and, when the handle is pushed, the frontmost staple of the staple cartridge, which is aligned with the ejection slot, is ejected by the punching blade of the handle to staple paper sheets, and the space where the frontmost staple was is filled with the staple cartridge, which is automatically attracted towards the ejection slot of the staple magazine by the magnetic attraction force of the front permanent magnet, thus making it possible to continuously conduct the stapling operation.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a perspective view showing a conventional stapler;

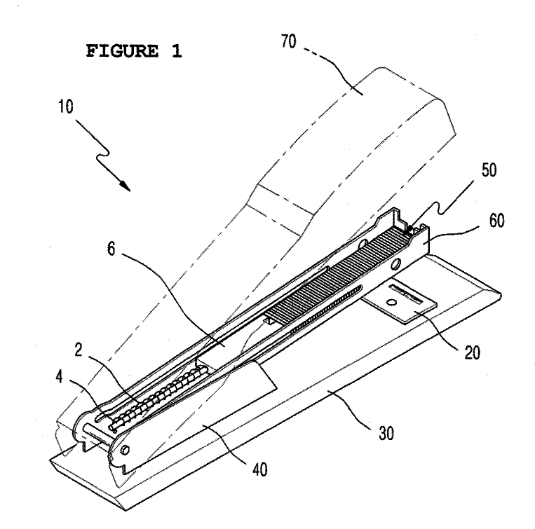

FIG. 2 is an exploded perspective view illustrating a stapler provided with a staple magazine having a permanent magnet, according to a preferred embodiment of the present invention;

FIG. 3 is a perspective view of the assembled stapler provided with the staple magazine having the permanent magnet according to the present invention; and

FIG. 4 illustrates a stapler provided with a staple magazine, which has permanent magnets on the front surface thereof and on the inner surface of the bottom thereof, according to another embodiment of the present invention.

### DESCRIPTION OF THE PREFERRED EMBODIMENTS

Hereinafter, preferred embodiments of the present invention will be described in detail with reference to the attached drawings.

The terms and words used in the specification and claims must not be limited to typical or dictionary meanings, but must be regarded as concepts selected by the inventor as the best method of illustrating the present invention, and must be interpreted as having meanings and concepts adapted to the scope and spirit of the present invention for understanding the technology of the present invention.

Therefore, the construction of the embodiments illustrated in the specification and the drawings must be regarded as only illustrative examples, which are not intended to limit the present invention. Furthermore, it must be understood that various modifications, additions, and substitutions are possible at the point of time of application of the present invention.

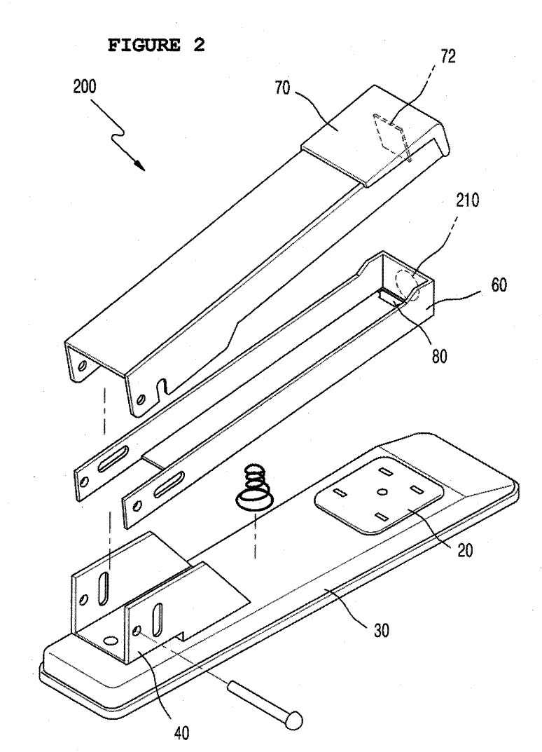

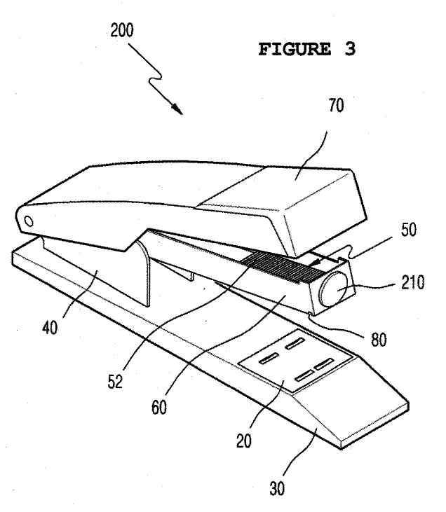

FIG. 2 is an exploded perspective view of a stapler provided with a staple magazine having a permanent magnet, according to an embodiment of the present invention. FIG. 3 is a perspective view of the assembled stapler provided with the staple magazine having the permanent magnet.

As shown in the drawings, the magnet stapler 200 according to the present invention includes a base 30, which has on a front end thereof an anvil 20 for bending a staple 52, and the lower surface of which is covered with a cover, and a support 40, which is provided on the rear end of the base 30 and has opposite sidewalls. The magnet stapler 200 further includes a staple magazine 60, which is rotatably coupled at the rear end thereof to the inner surfaces of the sidewalls of the support 40 and contains a staple cartridge 50 therein, and a handle 70, which covers the upper part of the staple magazine 60 and is rotatably coupled at the rear end thereof to the outer surfaces of the sidewalls of the support 40. The handle 70 has a punching blade 72 therein.

In the present invention, the staple magazine 60 of the magnet stapler 200 has no spring, no spring guide rod, no tension lever and no guide block therein, that is, the staple magazine 60 is empty except for staples.

Furthermore, a front permanent magnet 210 is provided on the front surface of the staple magazine 60, which contains the staple cartridge 50 therein, at a predetermined position adjacent to an ejection slot 80.

The front permanent magnet 210 is magnetic, and thus attracts iron pieces using its inherent magnetic force.

Therefore, the staple cartridge 50 having iron ingredients is pulled towards the ejection slot 80 of the staple magazine 60 by the attraction force of the front permanent magnet 210.

The frontmost staple in the staple cartridge 50, which is aligned with the ejection slot 80, is punched by the punching blade 72 of the magnet stapler 200 and is thus ejected outside through the ejection slot 80 so as to staple an object such as paper.

Here, when the frontmost staple is separated from the staple cartridge 50, which is contained in the staple magazine 60 of the magnet stapler 200, and is ejected outside through the ejection slot 80 of the staple magazine 60 to staple the paper sheets, the staple cartridge 50 is automatically pulled to the ejection slot 80 by the attraction of the magnetic force of the front permanent magnet 210, and fills the space previously occupied by the ejected staple. As such, every time a staple is ejected, the staple cartridge 50 of the staple magazine 60 is moved to the ejection slot 80 by the attraction of the magnetic force of the front permanent magnet 210.

In other words, after the frontmost staple 52 is ejected by the punching blade 72 through the ejection slot 80 of the staple magazine 60 to staple the paper, when the punching blade 72 is removed from the space between the staple cartridge 50 and the front wall of the staple magazine 60, the staple cartridge 50, contained in the staple magazine 60, is automatically moved towards the ejection slot 80 of the staple magazine 60 by the attraction of the magnetic force of the front permanent magnet 210, so that the staple cartridge 50 is brought into close contact with the inner surface of the front wall of the staple magazine 60.

In brief, in the present invention, the magnet stapler 200 has therein the staple magazine 60 for containing therein the staple cartridge 50, which is formed by consecutively attaching staples 52 to each other.

Furthermore, the front permanent magnet 210 is provided on the front surface of the front wall of the staple magazine 60 to pull the staple cartridge 50 using magnetic attraction force such that the staple cartridge 50 is brought into close contact with the front wall of the staple magazine 60.

Thus, every time a staple 52 is ejected outside in order to staple paper, the staple cartridge 50 is automatically moved towards the ejection slot 80 by the magnetic attraction force and fills the space previously occupied by the staple 52, such that the staple cartridge 50 is brought into close contact with the front wall of the staple magazine 60.

In addition, in the magnet stapler 200 of the present invention, a staple 52, which is disposed at the frontmost position of the staple cartridge 50 and is aligned with the ejection slot 80 of the staple magazine 60, is separated from the staple cartridge 50 and ejected through the ejection slot 80 by the punching blade 72 provided in the handle 79 of the magnet stapler 200, thus stapling paper.

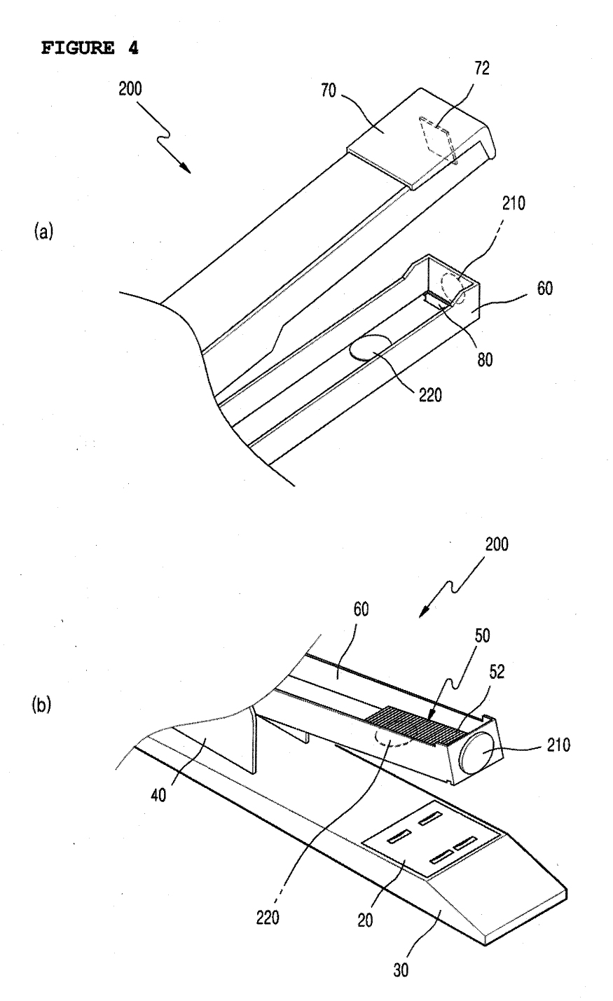

Meanwhile, FIG. 4 illustrates a stapler provided with a staple magazine, which has permanent magnets on the front surface thereof and on the inner surface of the bottom thereof, according to another embodiment of the present invention.

As shown in the drawing, in the magnet stapler 200 according to this embodiment, a bottom permanent magnet 220 is provided on the bottom of a staple magazine 60 to prevent a staple cartridge 50 from being undesirably removed from the staple magazine 60 using the magnetic attraction force of the bottom permanent magnet 220.

Furthermore, in the magnet stapler 200 of this embodiment, the bottom permanent magnet 220, which is provided on the bottom of the staple magazine 60, serves to hold the rear end of the staple cartridge 50 using the magnetic attraction force thereof such that the rear end of the staple cartridge 50 is prevented from being lifted from the bottom in the staple magazine 60 when the staple cartridge 50 is brought into contact with the front wall of the staple magazine 60. Of course, preferably, the magnetic force of the front permanent magnet 210, which is provided on the front wall of the staple magazine 60, is stronger than that of the bottom permanent magnet 220, which is provided on the bottom of the staple magazine 60, such that the bottom permanent magnet 220 does not interfere with the operation of the front permanent magnet 210, which attracts the staple cartridge 50 to the front wall of the staple magazine 60.

As such, in the magnet stapler 200 according to this embodiment, the staple cartridge 50 is continuously biased in the staple magazine 60 towards the front wall of the staple magazine 60 by the magnetic attraction force of the front permanent magnet 210, which is provided on the front wall of the staple magazine 60, and, simultaneously, the staple cartridge 50 is prevented from being undesirably lifted from the bottom of the staple magazine 60 by the bottom permanent magnet 220.

Furthermore, in the magnet stapler 200 of the present invention, the front permanent magnet 210 can securely hold the staple cartridge 50 using the magnetic attraction force thereof such that the staple cartridge 50 is in contact with the front wall of the staple magazine 60. Therefore, despite having a simple structure, the present invention has advantages in that the staple cartridge 50 can be reliably prevented from being removed from the staple magazine 60 and the staple cartridge 50 can be automatically and continuously brought into close contact with the front wall of the staple magazine 60.

Although the preferred embodiments of the present invention have been disclosed for illustrative purposes, the present invention is not limited to these embodiments, and those skilled in the art will appreciate that various modifications, additions and substitutions are possible, without departing from the scope and spirit of the invention as disclosed in the accompanying claims.

As described above, in a structure of a staple magazine having a permanent magnet according to the present invention, the permanent magnet is provided on the front wall of the staple magazine at a position adjacent to an ejection slot. Therefore, despite having a simple structure without using a separate complex holding structure using a spring for holding a staple cartridge such that it is brought into close contact with the front wall of the staple magazine, the prevent invention can be constructed such that the staple cartridge is reliably prevented from being undesirably removed from the staple magazine and is automatically and continuously brought into close contact with the front wall of the staple magazine. Furthermore, the present invention is advantageous in that, because the present invention requires the separate holding structure, such as the spring, the manufacturing time and costs are reduced.

What is claimed is:

1. A structure of a staple magazine for a stapler, including a base having on a front end thereof an anvil for bending a staple, a lower surface of the base being covered with a cover, a support provided on a rear end of the base, the support having opposite sidewalls, the staple magazine coupled at a rear end thereof to inner surfaces of the sidewalls of the support so as to be rotatable, the staple magazine containing a staple cartridge therein, and a handle for covering an upper part of the staple magazine, the handle being rotatably coupled at a rear end thereof to the sidewalls of the support, with a punching blade provided in the handle, the structure of the staple magazine comprising:
a front permanent magnet provided on a front wall of the staple magazine, which contains the staple cartridge therein, at a predetermined position adjacent to an ejection slot formed in the staple magazine, so that the staple cartridge is attracted towards the ejection slot of the staple magazine by a magnetic attraction force of the front permanent magnet, and, when the handle is pushed, a frontmost staple of the staple cartridge, which is aligned with the ejection slot, is ejected by the punching blade of the handle to bind paper sheets.

2. The structure of the staple magazine for the stapler as set forth in claim 1, wherein, when the frontmost staple is ejected to bind the paper sheets, the staple cartridge disposed in the staple magazine is moved to and is brought into close contact with the front wall of the staple magazine, adjacent to the ejection slot, by the magnetic attraction force of the front permanent magnet.

3. The structure of the staple magazine for the stapler as set forth in claim 1, wherein the staple cartridge is prevented from being removed from the staple magazine by the magnetic attraction force of the front permanent magnet.

4. The structure of the staple magazine for the stapler as set forth in claim 1, further comprising:
a bottom permanent magnet provided on a bottom of the staple magazine, so that a rear end of the staple cartridge is prevented from being lifted from a bottom of the staple magazine by a magnetic attraction force of the bottom permanent magnet.

5. A structure of a staple magazine for a stapler, including a base having on a front end thereof an anvil for bending a staple, a support provided on a rear end of the base, the support having opposite sidewalls, the staple magazine coupled at a rear end thereof to inner surfaces of the sidewalls of the support so as to be pivotable, the staple magazine sized to contain a staple cartridge therein, and a handle for covering an upper part of the staple magazine, the handle being pivotably coupled at a rear end thereof to the sidewalls of the support, with a punching blade provided in the handle, the structure of the staple magazine further comprising:
a front permanent magnet provided on a front wall of the staple magazine, which contains the staple cartridge therein, at a predetermined position adjacent to an ejection slot formed in the staple magazine, so that a staple cartridge contained therein is attracted towards the ejection slot of the staple magazine by a magnetic attraction force of the front permanent magnet.

6. The structure of the staple magazine for the stapler as set forth in claim 5, wherein a staple cartridge would be prevented from being removed from the staple magazine by the magnetic attraction force of the front permanent magnet.

7. The structure of the staple magazine for the stapler as set forth in claim 5, further comprising:
a bottom permanent magnet provided on a bottom of the staple magazine, so that a rear end of a staple cartridge is prevented from being lifted from a bottom of the staple magazine by a magnetic attraction force of the bottom permanent magnet.

8. A structure of a staple magazine for a stapler, including a base having on a front end thereof an anvil for bending a staple, a support provided on a rear end of the base, the support having opposite sidewalls, the staple magazine coupled at a rear end thereof to inner surfaces of the sidewalls of the support so as to be pivotable, the staple magazine sized to contain a staple cartridge therein, and a handle for covering an upper part of the staple magazine, the handle being pivotably coupled at a rear end thereof to the sidewalls of the support, with a punching blade provided in the handle, the structure of the staple magazine further comprising:
a bottom permanent magnet provided on a bottom of the staple magazine, so that a rear end of a staple cartridge is prevented from being lifted from a bottom of the staple magazine by a magnetic attraction force of the bottom permanent magnet.

9. The structure of the staple magazine for the stapler as set forth in claim 8, further comprising:
a front permanent magnet provided on a front wall of the staple magazine, which contains the staple cartridge therein, at a predetermined position adjacent to an ejection slot formed in the staple magazine, so that a staple cartridge contained therein is attracted towards the ejection slot of the staple magazine by a magnetic attraction force of the front permanent magnet.
